(19) United States
(12) Patent Application Publication
(10) Pub. No.: US 2025/0368515 A1
(43) Pub. Date: Dec. 4, 2025

(54) Method for Carbon Quantum DOT Synthesis

(71) Applicant: Amrita Vishwa Vidyapeetham, Coimbatore (IN)

(72) Inventors: Amala Devi S, Kollam (IN); Rajni Kamalam Sambasivam, Coimbatore (IN)

(73) Assignee: Amrita Vishwa Vidyapeetham, Coimbatore (IN)

(21) Appl. No.: 19/227,910

(22) Filed: Jun. 4, 2025

(30) Foreign Application Priority Data
Jun. 4, 2024 (IN) 202441043225

(51) Int. Cl. C01B 32/18; B82Y 20/00; B82Y 40/00; C09K 11/65

(52) U.S. Cl. CPC C01B 32/18; C09K 11/65; B82Y 20/00; B82Y 40/00; C01P 2004/64; C01P 2006/60

(57) ABSTRACT

The method for synthesizing Carbon Quantum Dots (CQDs) by leveraging concentrated energy source. A dual convex lens system focuses sunlight/energy source into a unique, Buckminster Fullerene-inspired chamber. This chamber, featuring mirrored and lensed internal faces, further concentrates heat onto a central quartz cuvette. Within this cuvette, a precursor derived from Tacoma Stans plant leaf extract, dissolved in volatile solvents, is pyrolyzed. This focused solar energy/other energy source and specialized chamber design enable the controlled pyrolysis of the plant extract, leading to the formation of CQDs.

### CROSS REFERENCE TO RELATED APPLICATIONS

The present application claims priority to a Provisional Application No. 202441043225 filed in India on Jun. 4, 2024. All disclosure of the Provisional Application is incorporated herein at least by reference.

### FIELD OF THE INVENTION

The present invention relates to a method of carbon quantum dot synthesis. More particularly, the present invention relates to method of synthesizing carbon quantum dot using the focused sunlight convergence ability of a convex lens.

### BACKGROUND OF THE INVENTION

Carbon Quantum Dots (CQDs) are particles of size less than 10 nm, with excellent photoluminescent properties. The discovery of these particles was accidental in 2004 during the electrophoretic purification of Multiwalled Carbon Nanotube (MWCNT) and was identified as photoluminescent impurity particles. Later in 2007, these particles were studied and identified as particles with optical tunability.

Modification of CQDs is also very important to get good surface properties which are essential for solubility and selected applications.

Being a new type of fluorescent nanoparticles, applications of CQD lie in the field of bioimaging and biosensing due to their biological and environmentally friendly composition and excellent biocompatibility. In order to survive the competition with conventional semiconductor quantum dots, a high quantum yield should be achieved.

Synthetic methods for CQDs are roughly divided into two categories, “top-down” and “bottom-up” routes. These can be achieved via chemical, electrochemical or physical techniques.

“Top-down” synthetic route refers to breaking down larger carbon structures such as graphite, carbon nanotubes, and nanodiamonds into CQDs using laser ablation, arc discharge, and electrochemical techniques. For example, Zhou et al. first applied electrochemical method into synthesis of CQDs. They grew multi-walled carbon nanotubes on a carbon paper, then they inserted the carbon paper into an electrochemical cell containing supporting electrolyte including degassed acetonitrile and 0.1 M tetrabutyl ammonium perchlorate. Later, they applied this method in cutting CNTs or assembling CNTs into functional patterns which demonstrated the versatile callability of this method in carbon nanostructure manipulations

The “Bottom-up” synthetic route involves synthesizing CQDs from small precursors such as carbohydrates, citrate, and polymer-silica nanocomposites through hydrothermal/solvothermal treatment, supported synthetic, and microwave synthetic routes. For instance, Zhu et al. described a simple method of preparing CQDs by heating a solution of poly(ethylene glycol) (PEG) and saccharide in 500 W microwave oven for 2 to 10 min. Also, a laser-induced thermal shock method is exploited for synthesis ultra-broadband QCDs.

A lot of single step one-pot synthesis methods were also identified for carbon dot synthesis. The temperature requirement for carbon dots is generally high, ranging from 90-400° C. in temperature-mediated reactions. The lowest temperature process for temperature-mediated synthesis is no-enzymatic glycosylation, in the natural physiological process of humans, which occurs at 37° C.

The method involved in the existing state of art is time taking, requires high energy consumption, generates low yield, whereas the present process involving the CDs synthesis requires short span of time which can be have wide applications like cooking solar energy based utensils designs. The synthesis chamber of the present invention also be used for other methods of synthesis, where heat and pressure are the requirement, along with water solution-based precursor set up. This can hence even be proof of the existence of CDs naturally, as these similar extreme conditions are even present naturally.

Therefore, the present invention is a breakthrough to the nano world and industrially useful technology transferrable.

### OBJECT OF THE INVENTION

The main object of the present invention is to provide a method for carbon quantum dot synthesis.

Another object of the invention is to provide a method for carbon quantum dot synthesis using the focused sunlight convergence ability of a convex lens.

Yet another object of the invention is to provide a method for carbon quantum dot synthesis which is rapid and result in high yield.

Yet another object of the invention is to provide a method for carbon quantum synthesis which is cost effective and scalable.

### SUMMARY OF THE INVENTION

Accordingly, the present invention relates to a method for carbon quantum dot synthesis. More particularly, the present invention relates to a novel approach for the synthesis of CDQs using the focused energy source such as sunlight convergence ability of a convex lens. The accumulation of concentrated solar energy at a single point on adjustment of a focal point of the lens to the sunlight has been achieved. As the parallel rays of sunlight passing through the lens converge at a point, a small amount of precursor material, if the lens is kept at this point, where the shadow of the sun appears, the carbon quantum dots can be formed. The formation of carbon dots can be confirmed with the change in luminescent properties of the obtained droplet to spot. Carbon quantum dots and polymer dots can be achieved via this synthesis procedure. The schematic representation of the same is as shown in FIG. 1.

The bottom-up method for synthesis, which can be used to deposit C-dots in the targeted spots for different applications, such as corrosion inhibition.

The chamber used in the method uses a TLC plate, which is metallic, double wall insulated with mirrors that can undergo total internal reflection inside the chamber. The construction of the chamber is in such a way that it can keep the focused energy inside the chamber, which can act as an energy resource for C-dot production, which resembles the principle of CSP (Concentrating solar collector).

Various plant-based extracts have been tried so far for the synthesis procedure. The targeted synthesis and coatings can be done on metallic pieces for corrosion inhibition applications using this method. The minimal impurity content can be ensured by using filtered extract precursors.

The production of CDs in a small beaker of 50 ml size inside a small chamber with mirrors arranged in such a way as multiple total internal reflections inside traps energy inside showed production of CDs in small amounts, which can vary according to the solar energy availability over the time span and can also be scaled up as per the industry requirement. In the absence of solar energy, the same experimental condition can be created using a low energy, monochromatic-coherent LASER source, so that the synthesis process can be continued even in the absence of sunlight, in an alternative method, where sunlight cannot be supplied for long.

A slight variation of this methodology can also have extended applications like cooking solar energy-based utensils designs. The synthesis chamber can be still used for other methods of synthesis, where heat and pressure are the requirement, along with water solution-based precursor set up.

Accordingly, the present invention provides a cost-effective method for carbon quantum dot production and is a breakthrough to the nano world and is industrially useful technology transferrable.

### BRIEF DESCRIPTION OF THE DRAWINGS

FIG. 1 depicts the schematic representation of experimental setup.

FIG. 2 depicts the Fullerene reflector chamber.

FIG. 3 depicts the UV-visible analysis result of Ethanol, Acetone and Methanol samples.

FIG. 4 (a) depicts For PL of Ethanol based sample.

FIG. 4 (b) depicts For PL of Acetone based sample.

FIG. 4 (c) depicts For PL of Methanol based sample.

### DETAILED DESCRIPTION OF THE INVENTION

Some embodiments of the present disclosure, illustrating all its features, will now be discussed in detail. It must also be noted that as used herein and in the appended claims, the singular forms “a”, “an” and “the” include plural references unless the context clearly dictates otherwise.

Various modifications to the embodiment will be readily apparent to those skilled in the art and the generic principles herein may be applied to other embodiments. However, one of ordinary skill in the art will readily recognize that the present disclosure including the definitions listed here below are not intended to be limited to the embodiments illustrated but is to be accorded the widest scope consistent with the principles and features described herein.

A person of ordinary skill in the art will readily ascertain that the illustrated steps detailed in the figures and here below are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Before discussing example, embodiments in more detail, it is to be noted that the drawings are to be regarded as being schematic representations and elements that are not necessarily shown to scale. Rather, the various elements are represented such that their function and general purpose becomes apparent to a person skilled in the art. Any connection or coupling between functional blocks, devices, components, or other physical or functional units shown in the drawings or described herein may also be implemented by an indirect connection or coupling.

A coupling between components may also be established over a wireless connection. Functional blocks may be implemented in hardware, firmware, software or a combination thereof.

Further, the flowcharts provided herein, describe the operations as sequential processes. Many of the operations may be performed in parallel, concurrently or simultaneously. In addition, the order of operations maybe re-arranged. The processes may be terminated when their operations are completed but may also have additional steps not included in the figured. It should be noted, that in some alternative implementations, the functions/acts/steps noted may occur out of the order noted in the figured. For example, two figures shown in succession may, in fact, be executed substantially concurrently, or may sometimes be executed in the reverse order, depending upon the functionality/acts involved.

Further, the terms first, second etc. may be used herein to describe various elements, components, regions, layers and/or sections, these elements, components, regions, layers and/or sections should not be limited by these terms. These terms are used only to distinguish one element, component, region, layer or section from another region, layer, or a section. Thus, a first element, component, region layer, or section discussed below could be termed a second element, component, region, layer, or section without departing form the scope of the example embodiments.

The terminology used herein is for the purpose of describing example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

The present invention discloses a breakthrough method for CQD synthesis by harnessing concentrated solar or laser energy in a novel, mirror-lined chamber, enabling green, scalable, and high-yield production with broad industrial applicability.

The invention is the integration of optical engineering (focused solar or laser energy) with a specially designed, energy-efficient reaction chamber for the green, scalable, and targeted synthesis of high-quality carbon quantum dots from plant-based materials. Said method is energy-efficient, environmentally friendly, cost-effective and have versatile for various applications and energy sources.

The present invention discloses a method for synthesizing carbon quantum dot (CQD), wherein said method comprising the steps of providing a reaction chamber having metallic, double-wall insulation and internal mirrors arranged for total internal reflection; introducing a solution comprising plant-based extracts dissolved in a volatile solvent into the reaction chamber; concentrating energy source onto the solution within the reaction chamber with or without the a convex lens, heating the solution and initiating the formation of CQDs; maintaining the solution under concentrated energy source for a period sufficient to form CQDs; and recovering the synthesized CQDs.

Various types of energy sources can be utilized for synthesis of CQDs such as solar energy or in case sunlight is not present then other types of energy can be utilized for synthesis of CQDs.

Sunlight is focused using a convex lens of focal length 5 mm is used to make rays convergent to a point, and then, this is again passed through a convex lens of same focal length. This entering into the chamber undergoes multiple reflections and concentrates on the central quartz cuvette (10 mm path length, 3.5 mL volume). The highly volatile solvents, specifically 95% pure Methanol (M), Acetone (A), and Ethanol (E), are utilized in quartz cuvettes. The concentration of these solvents used is in the range of 95% purity. Precursor materials are dissolved in these solvents at a concentration of 0.5 mg/mL and subsequently drop-casted. This is a bottom-up synthesis procedure, where precursor material used is Tacoma Stans plant leaf extract, with different solvents, such as ethanol, methanol and acetone and this is then drop casted on a TLC plate and in an A4 sheet paper, the solvent casted on A4 sheet paper got dissolved into the cuvette solution by itself, as cellulose containing paper got degraded faster due to the concentrated heat energy from both the sides of paper sheet, whereas the TLC plate sample settled on top of TLC itself. This is then needed to be dissolved and purified using usual post treatment methodologies such as centrifugation, syringe filtration and membrane filtration.

Whereas the precursor material placed over the A4 sheet got burned and the dust particles also got dissolved into the solution. After purification, the obtained Carbon Quantum Dots (CQDs) exhibited consistent characteristics, demonstrating that the type of plate used for deposition does not significantly impact their properties, if it is an easily flammable or flammable substance-coated plate.

The Quantum Yield (Q.Y.) of the purified CQDs was calculated using a relative method, with Quinine sulfate as the reference solvent. The measured Q.Y. values are as follows:
Acetone-derived CQDs: 67.4%,
Ethanol-derived CQDs: 63.7%, and
Methanol-derived CQDs: 52%.

Accordingly, all the samples demonstrated a Q.Y. exceeding 50%.

The sample mounting Quartz cuvette also contributes to the reflections that take part inside the chamber.

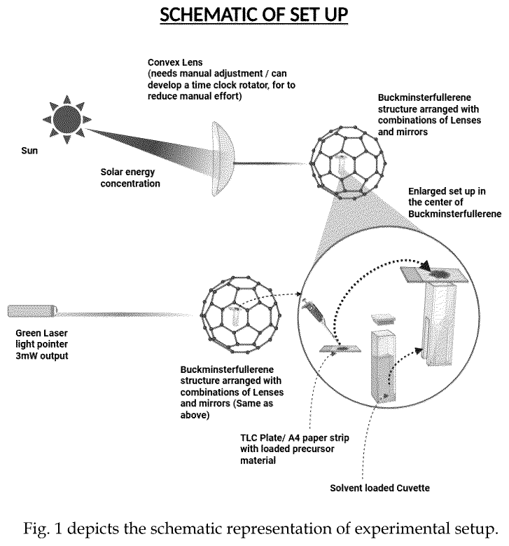

The chamber set up is as shown in FIG. 1. The schematic setup utilizes a solar power convergent lens to focus solar energy onto the entrance of a Buckminsterfullerene hexagonal chamber. Within this chamber, light is manipulated by a sophisticated optical arrangement. This includes four convex lenses, each with a focal length of 5 mm, strategically arranged at the four edges of the fullerene structure. The remaining internal surfaces of the hexagonal and pentagonal sides of the fullerene chamber are lined with 50 mm×50 mm mirrors.

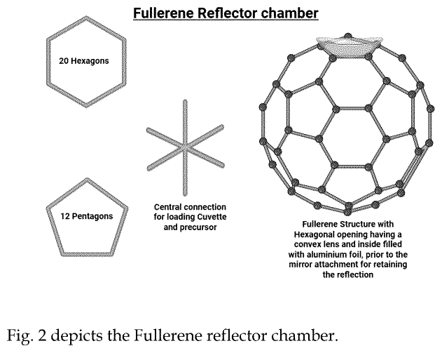

The entire chamber is enclosed by a double convex lens, serving as the exit or final optical element. This collision inside the chamber leads to multiple total internal reflections. The 12 pentagonal faces are fixed with mirrors and 20 hexagonal faces with lenses as shown in FIG. 2, over the aluminum foil covered cardboard sheets. This is then assigned in a way that the sample and cuvette (3 ml) can be kept inside through a middle hexagonal cavity that is removable and can be replaced. The sample placing A4 sheet paper/TLC is of size (30 mm×30 mm), which can be adjusted and increased proportionally to that of the chamber that we are using. The industrial level scaling up of set up is hence can be done cost-efficiently, with natural precursor material and using solar power consumption.

The proposed method to potentially improve industrial working hours involves the use of a commercially available 3mW green laser light pointer. The process entails a continuous laser beam from the 3 mW green laser pointer is applied for a duration ranging from 200 to 250 seconds. This irradiation sequence is repeated three times in a row. A time duration of 120 seconds (2 minutes) is observed between each successive laser beam irradiation.

This result also shows a better yield, as this can be practiced at night timings or whenever the sunlight availability is poor. This method hence provides a backup plan for the industries with poor sunlight availability and during night hours. The inner set ups are same as sunlight concentration, but there is no need of convex lens set up for concentrated beam, the set-up is depicted along with sunlight mediated preparation as shown in FIG. 1.

The aforementioned procedure is a method for synthesis, which is used to deposit C-dot in the targeted spots for different applications, such as corrosion inhibition. The chamber which is used to keep the TLC plate is metallic, double wall insulated with mirrors that can undergo total internal reflection inside the chamber. The construction of the chamber is in such a way that it can keep the energy focused inside the chamber, which can act as an energy resource for CD production, which resembles the principle of CSP (Concentrating solar collectors).

Plant-based extracts (ethanolic/methanolic/acetone) have been tried so far for the synthesis procedure. The targeted synthesis and coatings can be done on metallic pieces for corrosion inhibition applications using this method. The minimal impurity content can be ensured by using filtered extract precursors.

### Results

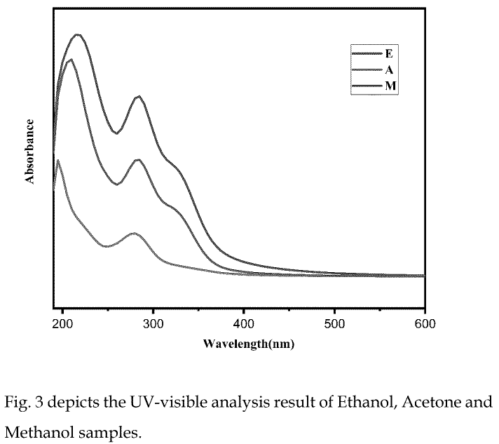

UV-Visible Analysis Result for solvents, Ethanol (E), Acetone (A), and Methanol (M) are shown in FIG. 3. The dominant peaks are seen at 217 nm and 284 nm for Ethanol solvents, 209 nm and 282 nm for Aceton solvents as well as 194 nm and 279 nm for Methanol solvents are characteristics for CQD, corresponding to n-π* and π-π* transitions of sp2 hybridized carbon core structures present in the sample. The inset figure shows fluorescent nature of prepared sample under UV-light.

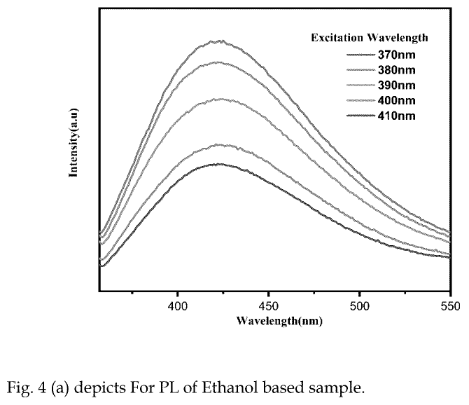

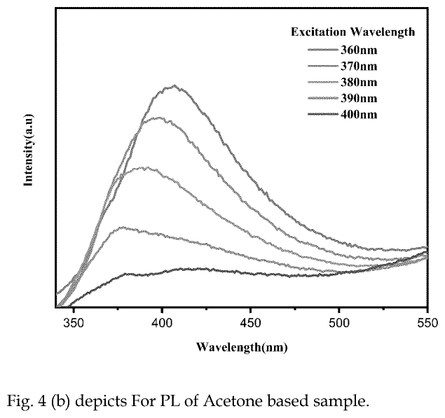

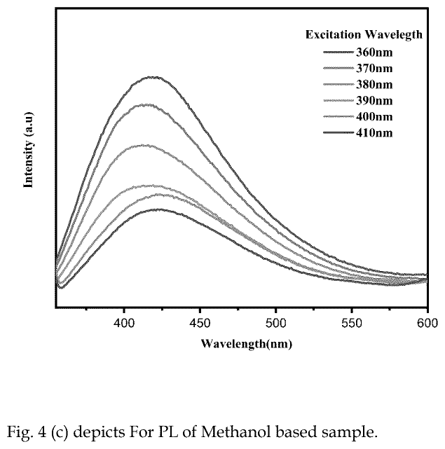

PL Analysis Results for the same set of samples synthesized are as shown in FIG. 4(a): For PL of Ethanol solvent-based sample, 4(b): For PL of Acetone based sample and 4(c): For PL of Methanol solvent-based sample. The excitation-dependent emission with blue shift is shown by the samples, which indicates the formation of CQDs. The Ethanol sample for 370 nm to 410 nm excitation wavelength shows 422 nm to 416 nm shift, the shift points for acetone sample shows 422 corresponds to 370 nm excitation and 416 corresponds to 410 nm excitation. The methanol sample results for the same are 418 for 360 nm and 414 for 410 nm excitation. These results are the best indication of CQDs formation.

The excitation wavelengths given lies in the range of 360-410 nm, which corresponds to the formation of CQDs, with the resultant excitation-dependent emission with blue-shift. These confirmations along with the UV-Visible absorption peaks and the colour change of the solution under UV-light shows clearly the formation of CQDs.

Accordingly, the invention provides the following advantages:
Solar Energy Utilization: The core of the method involves using a convex lens to converge sunlight to a single focal point, providing concentrated solar energy for CQD formation.
Enclosed Reaction Chamber: A specially designed chamber, featuring metallic, double-wall insulation and internal mirrors for total internal reflection, traps and utilizes the concentrated energy. This design mimics the principle of Concentrating Solar Power (CSP) systems.
Cost Effective and Greener Precursor Materials: Plant-based extracts, dissolved in highly volatile solvents such as methanol, acetone, and ethanol serve as precursor materials.
Versatile Deposition: The method allows for targeted synthesis and coating of CQDs on various substrates, including TLC plates and A4 sheet paper, and importantly, on metallic pieces for corrosion inhibition.
Alternative Energy Source: In the absence of sufficient sunlight, a low-energy, monochromatic-coherent LASER source (e.g., a 3 mW green laser pointer) can be used to continue the synthesis process, ensuring continuous production.
High Quantum Yield: The synthesized CQDs exhibit high Quantum Yield (Q.Y.).
Scalability: The method is described as industrially scalable and cost-efficient due to the use of natural precursor materials and solar power.

We claim:

1. A method for synthesizing carbon quantum dot (CQD), wherein said method comprising the steps of:
a. providing a reaction chamber having metallic, double-wall insulation and internal mirrors arranged for total internal reflection;
b. introducing a solution comprising plant-based extracts dissolved in a volatile solvent into the reaction chamber;
c. concentrating energy source onto the solution within the reaction chamber with or without by means of a convex lens,
d. heating the solution and initiating the formation of CQDs;
e. maintaining the solution under concentrated energy source for a period sufficient to form CQDs; and
f. recovering the synthesized CQDs, enabling green, scalable, and targeted CQDs production.

2. The method as claimed in claim 1, wherein said energy source is solar energy or laser beam using a 3 mW green laser light pointer as the laser source, applied for a duration for 200 to 250 seconds.

3. The method as claimed in claim 1 wherein said reaction chamber comprises of Buckminster fullerene hexagonal chamber, includes four convex lenses, each with a focal length of 5 mm, strategically arranged at the four edges of the fullerene structure, the remaining internal surfaces of the hexagonal and pentagonal sides of the fullerene chamber are lined with 50 mm×50 mm mirrors, the entire chamber is enclosed by a double convex lens, serving as the exit or final optical element.

4. The method as claimed in claim 1 wherein said organic solvent as utilized are selected from Ethanol(E), Acetone (A), or Methanol(M) with 95% purity.

5. The method as claimed in claim 1 wherein said method provides a cost effective. scalable and provides a high quantum yield of the CQDs.
